(19) United States
(12) Patent Application Publication
(10) Pub. No.: US 2026/0329484 A1
(43) Pub. Date: Oct. 22, 2026

(54) STORAGE SYSTEM, POWER CONSUMPTION ESTIMATION METHOD, AND MANAGEMENT TERMNAL

(71) Applicant: Hitachi Vantara, Ltd., Yokohama-shi (JP)

(72) Inventors: Tomoki SHOJI, Tokyo (JP); Masanori TAKADA, Tokyo (JP)

(21) Appl. No.: 19/538,244

(22) Filed: Feb. 12, 2026

(30) Foreign Application Priority Data
Apr. 17, 2025 (JP) 2025-068410

(51) Int. Cl. G06F 3/06

(52) U.S. Cl. CPC G06F 3/067

(57) ABSTRACT

In order to solve the above problem, a controller estimates power consumption of each of a plurality of devices based on device power reference information in which types of devices, power modes, load indexes, and power consumption are associated with each other, and operational history information including the acquired power modes and load indexes of the plurality of devices.

### CLAIM OF PRIORITY

The present application claims priority from Japanese patent application JP 2025-068410 filed on Apr. 17, 2025, the content of which is hereby incorporated by reference into this application.

### ACKGROUND OF THE INVENTION

### 1. Field of the Invention

The present invention relates to a technique for estimating power consumption of a storage system.

### 2. Description of the Related Art

In recent years, a reduction in power consumption of an IT system has become an important social problem from the viewpoint of sustainability or the like, and power saving is also required in a storage system. In order to reduce power of a storage system, it is important to grasp power consumption of a storage system and accurately control the power consumption.

For example, JP 2010-97555 A discloses a technique for estimating power using a relational expression in which a load and power of each unit are proportional. By recording a load for each logical partition (logical volume) of a storage area, an increase amount of power for each logical volume is derived from the relational expression between the load and the power. In addition, JP 2010-97555 A discloses a technique for estimating power consumed by a physical drive based on a physical drive state and a physical drive power specification table when the physical drive power specification table indicating a relationship between a plurality of states and power for the physical drive is provided.

In a storage system, there are actually I/Os from a plurality of types of applications. PCT International Publication No. WO2011/016081 discloses a technique for estimating power consumption for each application using a storage system. This is implemented by acquiring information in which an application and a logical volume are associated with each other in addition to a power consumption estimation technique for each hardware component and logical volume of a storage system as in JP 2010-97555 A.

### SUMMARY OF THE INVENTION

Hardware mounted in recent storage systems has a plurality of power modes according to loads. Power of the hardware is determined by a power mode and a load according to the load. Therefore, since the relationship between the load and the power is nonlinear, the power cannot be correctly estimated by a scheme in which "an operating rate and power are proportional" or "power is determined only by a state of hardware" as in JP 2010-97555 A.

The present invention has been made in view of the above circumstances, and proposes a method of estimating power consumption of a storage system with high accuracy.

A representative example of the present invention disclosed in the present application is as follows. That is, in a storage system on which a plurality of devices are mounted, at least one of the devices operates in a plurality of power modes. The plurality of devices include a controller and a plurality of storage devices. The controller holds device power reference information for storing data associating types of devices, power modes, and load indexes with power consumption, acquires an operational history including the power modes and the load indexes of the plurality of devices, and estimates power consumption of each of the plurality of devices with reference to the device power reference information based on the operational history.

According to the present invention, it is possible to estimate power consumed by the storage system with high accuracy. Problems, configurations, and effects other than those described above will be clarified by the following description of examples.

### BRIEF DESCRIPTION OF THE DRAWINGS

FIG. 1 is a diagram illustrating an example of a configuration of a system according to Example 1;

FIG. 2 is a diagram illustrating a functional configuration of a power management unit included in a storage system according to Example 1;

FIG. 3 is a diagram illustrating an example of information stored in an information storage area of a memory of a management terminal according to Example 1;

FIG. 4 is a diagram illustrating an example of a data structure of device power reference information according to Example 1;

FIG. 5 is a graph illustrating a relationship between a power mode and power consumption of a device mounted in the storage system according to Example 1;

FIG. 6 is a diagram illustrating an example of a data structure of operational history information according to Example 1;

FIG. 7 is a flowchart illustrating an example of update processing of the operational history information executed by the management terminal according to Example 1;

FIG. 8 is a flowchart illustrating power consumption estimation processing executed by the management terminal according to Example 1;

FIG. 9 is a diagram illustrating an example of presentation of an estimation result of power consumption by the management terminal according to Example 1;

FIG. 10 is a diagram illustrating an example of information stored in an information storage area of a memory of a management terminal according to Example 2;

FIG. 11A is a diagram illustrating an example of a data structure of operational history information according to Example 2;

FIG. 11B is a diagram illustrating an example of a data structure of operational history information according to Example 2;

FIG. 12 is a diagram illustrating an example of a data structure of application configuration information according to Example 2;

FIG. 13 is a flowchart illustrating power consumption estimation processing executed by the management terminal according to Example 2;

FIG. 14 is a diagram illustrating an example of presentation of an estimation result of power consumption by the management terminal according to Example 2;

FIG. 15 is a diagram showing an example of presentation of an estimation result of power consumption by the management terminal according to Example 2.

FIG. 16 is a diagram illustrating an example of information stored in an information storage area of a memory of a management terminal according to Example 3;

FIG. 17 is a diagram illustrating an example of a data structure of simulation information according to Example 3;

FIG. 18 is a diagram illustrating an example of a power simulation screen displayed on an output device by the management terminal according to Example 3 in order to execute power simulation; and

FIG. 19 is a flowchart illustrating a power simulation executed by the management terminal according to Example 3.

### DESCRIPTION OF THE PREFERRED EMBODIMENTS

Hereinafter, examples of the present invention will be described with reference to the drawings. However, the present invention is not to be construed as being limited to the description of the following examples. Those skilled in the art can easily understand that a specific configuration can be changed without departing from the spirit or gist of the present invention.

In configurations of the invention to be described below, the same or similar configurations or functions are denoted by the same reference numerals, and repeated description is omitted. The same type of different elements are distinguished by adding suffixes to the same reference numerals. For example, controllers 111-1 and 111-2 represent different individuals of the same type of controllers, and the controller 111 represents one or both of controllers 111-1 and 111-2.

Notations such as "first", "second", and "third" in the present specification and the like are given to identify components, and do not necessarily limit numbers or orders.

A position, size, shape, range, and the like of each configuration illustrated in the drawings and the like may not represent an actual position, size, shape, range, and the like in order to facilitate understanding of the invention. Accordingly, the present invention is not limited to the positions, sizes, shapes, ranges, and the like disclosed in the drawings and the like.

### Example 1

In Example 1, power consumption of a storage system is estimated based on loads of constituent components included in a storage system and an operating power mode.

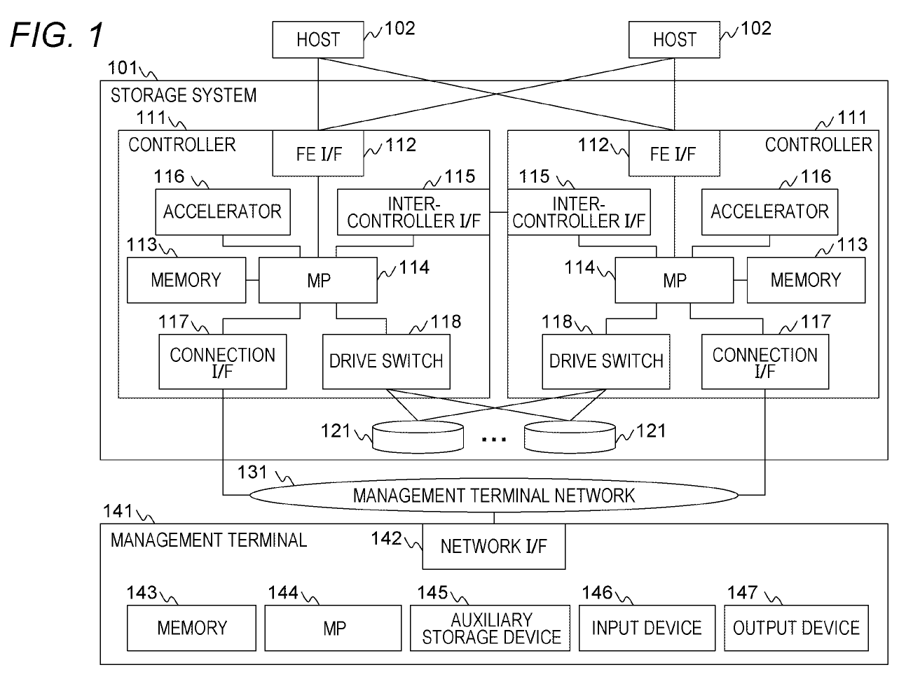

FIG. 1 is a diagram illustrating an example of a configuration of a system according to Example 1. The system includes a storage system 101, a host 102, and a management terminal 141.

The host 102 is a computer device that transmits a data read command and a data write command to the storage system 101 based on a user operation or an operation of application software or the like. The host 102 may be a virtual computer device such as a virtual machine.

In FIG. 1, the number of hosts 102 connected to the storage system 101 is two, but may be one or three or more.

One or more controllers 111 and one or more physical drives 121 are mounted on the storage system 101. The storage system 101 according to Example 1 has a dual controller configuration including two controllers 111, but one controller 111 may be provided or a cluster configuration in which three or more controllers are connected to each other may be provided.

The controller 111 includes a front-end interface (FE I/F) 112, a memory 113, a processor (MP) 114, an inter-controller interface (inter-controller I/F) 115, an accelerator 116, a connection interface (connection I/F) 117, and a drive switch 118.

The FE I/F 112 connects the host 102 and the storage system 101. The FE I/F 112 converts a data transfer protocol between the host 102 and the controller 111 and a data transfer protocol within the controller 111.

The host 102 and the FE I/F 112 are connected according to a communication standard such as fiber channel or Ethernet. The host 102 and the FE I/F 112 may be connected via a storage area network including a plurality of transmission lines and a plurality of switches.

The memory 113 is a main storage device used by the MP 114. The memory 113 includes, for example, a program storage area for storing a program executed by the MP 114, an information storage area for storing information such as management information referred to by the MP 114, and a cache area for temporarily storing data when user data is transferred. Information regarding operational states of the constituent components of the storage system 101, and the like are stored in the information storage area.

The MP 114 controls storage processing of the storage system 101. For example, the MP 114 controls data transfer with the host 102 connected via the FE I/F 112, the physical drive 121 connected via the drive switch 118, the accelerator 116, the controllers 111 connected via the inter-controller I/F 115, and the like.

Furthermore, in the present example, the MP 114 monitors an operational state of the controller 111 and the like for power consumption estimation.

The inter-controller I/F 115 connects the MPs 114 included in the controllers 111-1 and 111-2 to each other.

The accelerator 116 is a dedicated hardware circuit that can execute a part of the storage processing executed by the MP 114 instead. For example, the MP 114 may offload at least a part of encoding processing of data stored in drive to the accelerator 116. The encoding processing includes, for example, compression processing of data to be written to the physical drive 121, decompression processing when compressed data stored in the physical drive 121 is read, encryption processing of data to be written to the physical drive 121, and decryption processing of encrypted data stored in the physical drive 121.

The connection I/F 117 connects the controller 111 and the management terminal 141 via the management terminal network 104.

The drive switch 118 connects the physical drive 121 to the MP 114.

In the present specification, constituent components that can be mounted on the storage system 101, such as the FE I/F 112, the memory 113, the MP 114, the inter-controller I/F 115, the accelerator 116, the drive switch 118, and the physical drive 121, are referred to as "devices". A device actually mounted on the storage system 101 will be referred to as a "mounted device".

The "devices" are not limited to those illustrated in FIG. 1. In addition, for example, devices related to a power supply, a cooling fan, and the like may be included.

In the present specification, each device switches between a plurality of power modes in accordance with a load. As examples of the power modes, for example, when a nonvolatile memory express solid state drive (NVMe solid state drive) is assumed as the physical drive 121, an autonomous power state transition (APST), and the like, which are functions provided by the SSD, correspond. The APST can transition to a power saving state in which power is reduced by stopping an operation when no load is applied to the drive, a state in which the APST operates while suppressing power consumption although a data reading/writing speed decreases, and the like.

The power mode may be uniquely defined in the storage system 101 in addition to the device standard such as APST. For example, the MP 114 can be regarded as having a plurality of power modes in which a processing capability and power consumption have different characteristics by controlling an operating frequency, the number of operating cores, and the like. When the controller 111 dynamically controls the operating frequency and the number of operating cores of the MP 114 according to a load, the MP 114 can operate in a plurality of power modes.

The concept of the power modes can be applied not only to devices but also to transmission paths between devices. For example, the MP 114 and other devices are connected by Peripheral Component Interconnect Express (PCIe). PCIe includes active state power management (ASPM) as a power management function. In the ASPM, when a PCIe link is active, the PCIe link is in an L0 state and has maximum power consumption. When the transaction of the PCIe link is not performed, the PCIe link transitions to an L0s state or an L1 state as the power saving state of the ASPM. In the PCIe link, a data transfer rate, power consumption, and the like also change in accordance with a link speed and a link width. Accordingly, the power consumption of the PCIe link can be controlled not only by the ASPM but also by dynamically switching and controlling the link speed and the link width.

In the present example, a power consumption estimation method of a storage system that controls each device in a plurality of power modes will be described below. The "devices" may also include a transmission path between devices.

The management terminal 141 is a terminal that manages the storage system 101. The management terminal 141 includes, for example, a network interface (network I/F) 142, a memory 143, an MP 144, an auxiliary storage device 145, an input device 146, and an output device 147.

The network I/F 142 connects the management terminal 141 and the controller 111 via the management terminal network 131.

The MP 144 is a processor that controls the management terminal 141, and operates based on a management program stored in the memory 143.

The memory 143 stores not only the management program executed by the MP 144 but also power management information used for estimating power consumption of the storage system 101.

The auxiliary storage device 145 is nonvolatile by reading and writing programs and management information stored in the memory 143. The input device 146 is used when a user operates the management terminal 141. The output device 147 is used when the user refers to information that the management terminal 141 has.

In the present example, the management terminal 141 has a configuration independent of the storage system 101, but the management terminal may be built in the storage system 101.

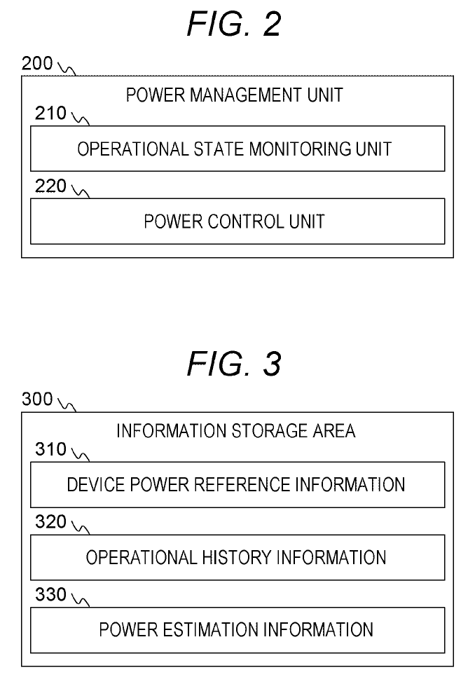

FIG. 2 is a diagram illustrating a functional configuration of a power management unit included in the storage system 101 according to Example 1.

The power management unit 200 is implemented by the MP 114 executing a program stored in a program storage area of the memory 113. The power management unit 20 includes an operational state monitoring unit 210 and a power control unit 220.

The operational state monitoring unit 210 monitors an operational state of a device mounted on the storage system 101.

The power control unit 220 controls a power mode of each mounted device based on a monitoring result of the operational state by the operational state monitoring unit 210.

FIG. 3 is a diagram illustrating an example of information stored in the information storage area 300 of the memory 143 of the management terminal 141 according to Example 1.

The information storage area 300 stores, for example, device power reference information 310, operational history information 320, and power estimation information 330.

The device power reference information 310 is information for managing parameters that are referred to when the power consumed by the mounted device of the storage system 101 is estimated. For example, it is conceivable that the device power reference information 310 is generated based on information obtained by evaluating power consumption of the mounted device of the storage system 101 in advance.

The operational history information 320 stores an operational history including a processing load of each mounted device, an operating power mode, and the like.

In the power estimation information 330, an estimation result of the power consumption of each mounted device and an estimation result of the power consumption of the entire storage system 101 are stored.

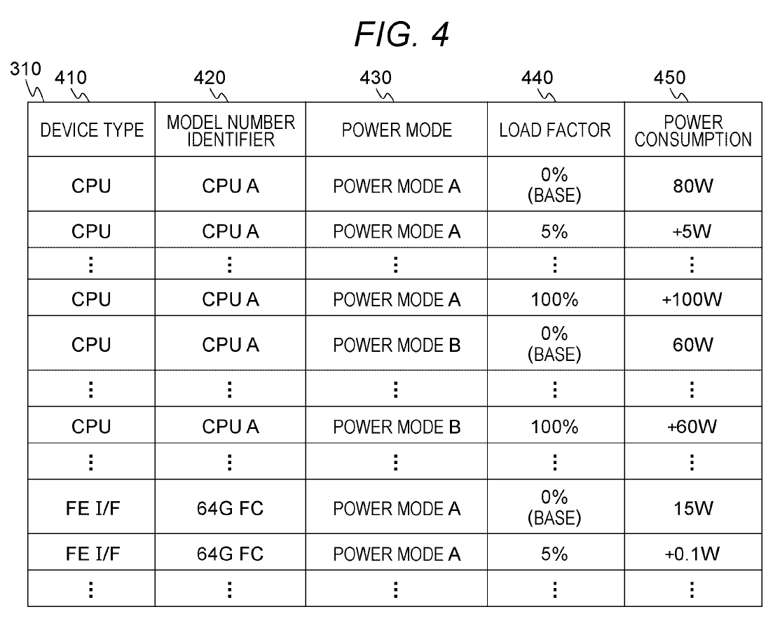

FIG. 4 is a diagram illustrating an example of a data structure of the device power reference information 310 according to Example 1.

The device power reference information 310 stores, for example, an entry including a device type 410, a model number identifier 420, a power mode 430, a load factor 440, and power consumption 450.

The device type 410 is a field where an identifier indicating a type of device such as the MP 114 or the FE I/F 112 in the storage system 101 illustrated in FIG. 1 is stored.

The model number identifier 420 is a field where an identifier indicating a model number of the device indicated by the device type 410 is stored.

The power mode 430 is a field where an identifier indicating a power mode in which the device operates is stored.

The load factor 440 is a field where a load factor in the device indicated by the device type 410 and the model number identifier 420 is stored. When a processing capacity is 100%, the load factor can take a value from 0% to 100% according to a load amount per unit time. Instead of the load factor 440, a field where an index directly representing the degree of load, such as a throughput value processed by the device, is stored may be provided.

The power consumption 450 indicates power consumption when each device is in an operational state described in the power mode 430 and the load factor 440. The power consumption in a state where the load factor is 0% is referred to as base power consumption. The power consumption of each power mode is managed in increments from the base power consumption.

The device power reference information 310 may include not only information regarding devices included in a current configuration of the storage system 101 but also a device model number that can be additionally installed during a change in configuration. Accordingly, for example, in order to expand a capacity of the storage system 101, the power consumption can be estimated during a change in configuration such as addition or replacement of the physical drive 121.

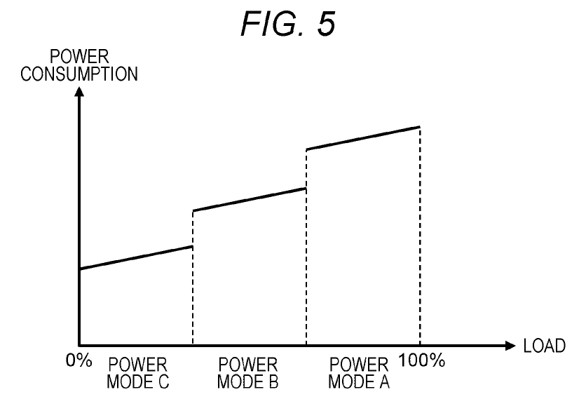

The reason why the entry stored in the device power reference information 310 includes the power mode 430 and the load factor 440 is that the power consumption of the device is determined in accordance with the power mode and the load factor. This will be described with reference to FIG. 5.

FIG. 5 is a graph illustrating a relationship between a power mode and power consumption of a device mounted in the storage system 101 according to Example 1. The horizontal axis represents a load, and the vertical axis represents power consumption.

As illustrated in FIG. 5, as the load increases, the power consumption also increases. As described above, the device mounted in the storage system 101 is switched to a plurality of power modes according to the load. At a switching point of the power mode, the power consumption does not smoothly continue, and the power consumption nonlinearly changes in a stepped form.

The present invention provides a power consumption estimation mechanism in consideration of both the power mode and the load factor, and thus estimation accuracy can be improved as compared with a method of estimating the power consumption using only one of the power mode and the load factor.

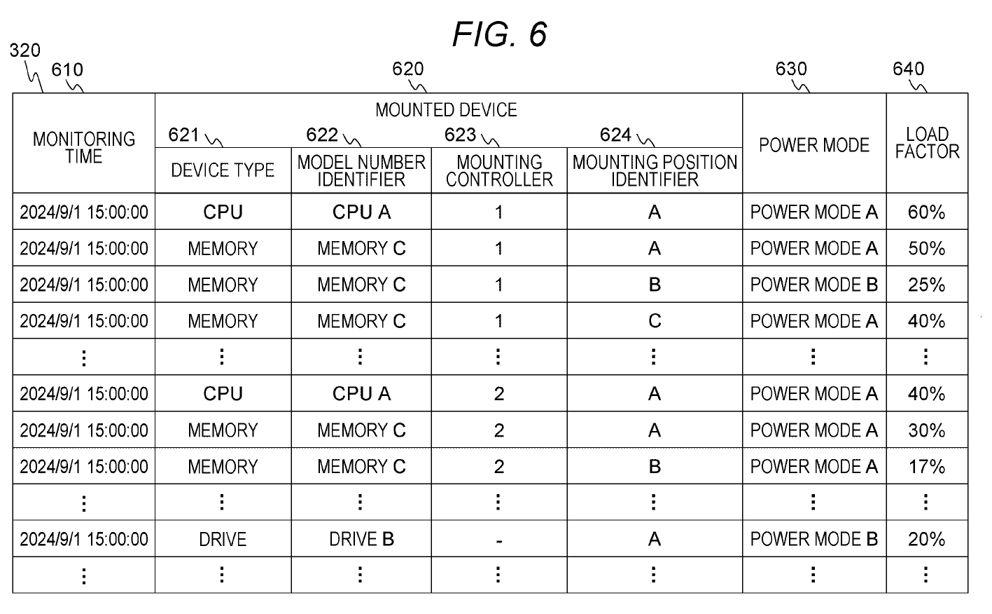

FIG. 6 is a diagram illustrating an example of a data structure of the operational history information 320 according to Example 1.

The operational history information 320 stores, for example, an entry including a monitoring time 610, a mounted device 620, a power mode 630, and a load factor 640.

The monitoring time 610 is a field where a time at which an operational state of each mounted device is acquired is stored. In the monitoring time 610, for example, an elapsed time from start of the storage system 101 is stored.

The mounted device 620 includes a device type 621, a model number identifier 622, a mounted controller 623, and a mounting position identifier 624.

A type of each mounted device can be specified in accordance with the device type 621 and the model number identifier 622. When the same type of plurality of devices is mounted, such as a memory and a physical drive, the mounting position identifier 624 is used to specify which mounted device is indicated. A specific position of each mounted device can be specified in accordance with the mounted controller 623 and the mounting position identifier 624.

The power mode 630 is a field where a power mode which is monitored by the operational state monitoring unit 210 and in which the mounted device operates is stored.

The load factor 640 is a field where a load factor per unit time of the mounted device is stored. The load factor 640 of the operational history information 320 is a field where power is estimated in association with the load factor 440 of the device power reference information 310. Therefore, when a field where an index directly representing the load amount is stored is provided instead of the load factor 440 of the device power reference information 310, it is desirable to change the load factor 640 of the operational history information 320 to a field where a similar index is stored and record the field.

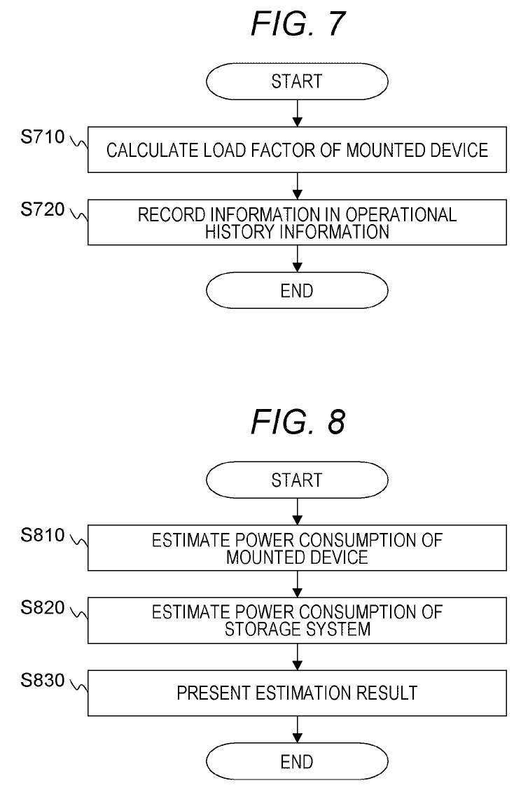

FIG. 7 is a flowchart illustrating an example of update processing of the operational history information 320 executed by the management terminal 141 according to Example 1.

The operational state monitoring unit 210 periodically acquires information regarding the power mode and the load of each mounted device and transmits the information to the management terminal 141. Any monitoring cycle can be set.

In step S710, the management terminal 141 calculates a load factor of each mounted device using the information received from the operational state monitoring unit 210 and the information regarding a processing capability of each mounted device. In order to calculate a load factor of the mounted device, for example, it is assumed that the management terminal 141 holds information regarding the processing capability of the mounted device in advance.

In step S720, the management terminal 141 records, for each mounted device, the monitoring time, the power mode, and the calculated load factor in the entry of the operational history information 320 corresponding to identification information of the mounted device.

In this flow, the MP 144 of the management terminal 141 calculates the load factor, but the MP 114 of each controller 111 may calculate the load factor. In this case, information regarding the processing capability of each device is stored in the memory 113 in advance, and the MP 114 appropriately calculates the load factor with reference to the information.

When a field where the load amount is stored is provided instead of the load factor 640 of the entry of the operational history information 320, the management terminal 141 registers the load amount received from the operational state monitoring unit 210 in the operational history information 320 as it is without executing the processing of step S710.

FIG. 8 is a flowchart illustrating power consumption estimation processing executed by the management terminal 141 according to Example 1.

In step S810, the management terminal 141 estimates power consumption of each mounted device based on the operational history of the operational history information 320 and information regarding the corresponding device of the device power reference information 310. Specifically, the management terminal 141 searches for an entry in which a combination of the device type 410, the model number identifier 420, the power mode 430, and the load factor 440 matches a combination of the device type 621, the model number identifier 622, the power mode 630, and the load factor 640 of the operational history, and reads the power consumption 450 of the searched entry.

In step S820, the management terminal 141 estimates the power consumption of the entire storage system 101 by adding estimation results of the power consumption of all the mounted devices. The management terminal 141 records the estimation result of the power consumption in the power estimation information 330.

In step S830, the management terminal 141 presents the estimation result of the power consumption to the user via the output device 147.

In the present example, the management terminal 141 is an entity that estimates the power consumption of each mounted device as an example, but the storage system 101 (the MP 114) may estimate the power consumption.

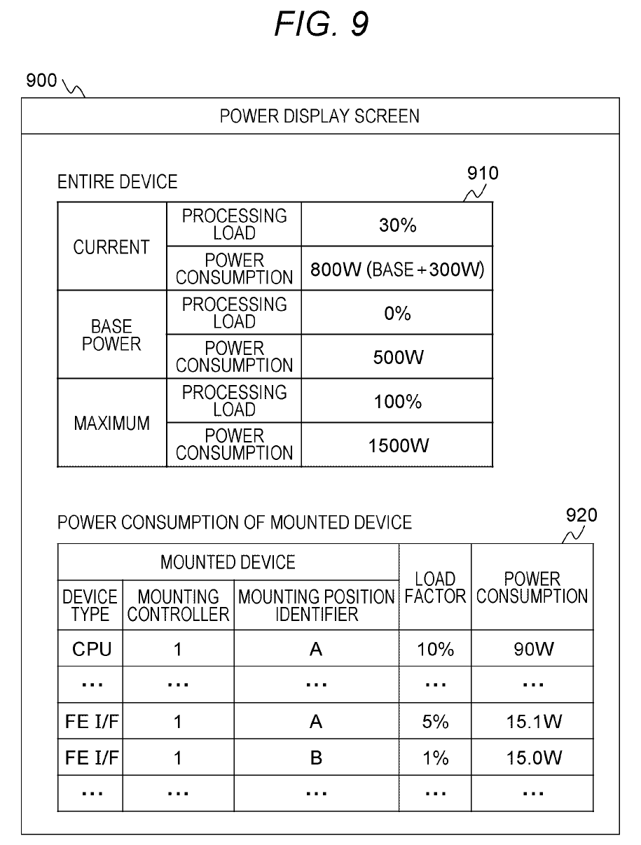

FIG. 9 is a diagram illustrating an example of presentation of an estimation result of power consumption by the management terminal 141 according to Example 1.

The management terminal 141 displays a power display screen 900 on the output device 147. The power display screen 900 includes an entire device power area 910 and a mounted device power area 920.

The entire device power area 910 is an area where a current power consumption in the entire storage system 101 is displayed. In the entire device power area 910, as an example, in addition to the current power consumption, a rough indication of the current magnitude of the processing load may be displayed. In addition, as information, a state in which the storage system 101 is energized but has no processing load may be displayed as base power consumption, or power consumption in a case of a maximum load that can be processed by the storage system 101 may be displayed.

The mounted device power area 920 is an area where the power consumption of each mounted device is displayed. In the mounted device power area 920, for example, an entry including identification information, a load factor, and power consumption of the mounted device is displayed. A user can ascertain how much load is applied to which mounted device, resulting in an increase in power consumption with reference to the table.

As described above, according to Example1, the power consumption of the storage system 101 can be estimated with high accuracy by estimating the power consumption based on the load and the power mode of each mounted device of the storage system 101.

### Example 2

In Example 2, in addition to estimation of power consumption for each mounted device described in Example 1, power consumption of the storage system 101 is separately estimated for each application.

In Example 2, description of the same configuration and operation as those of Example 1 will be omitted, and portions different from those of Example 1 will be mainly described.

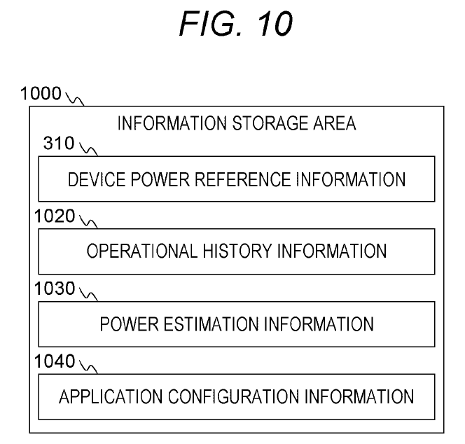

FIG. 10 is a diagram illustrating an example of information stored in an information storage area 1000 of the memory 143 of the management terminal 141 according to Example 2.

The information storage area 1000 according to Example 2 newly includes application configuration information 1040.

Operational history information 1020 according to Example 2 is different from the operational history information 320 according to Example 1 in that a load factor of a logical volume unit is recorded. Power estimation information 1030 according to Example 2 is different from the power estimation information 330 of Example 1 in that power consumption of the storage system 101 is separately recorded in units of applications.

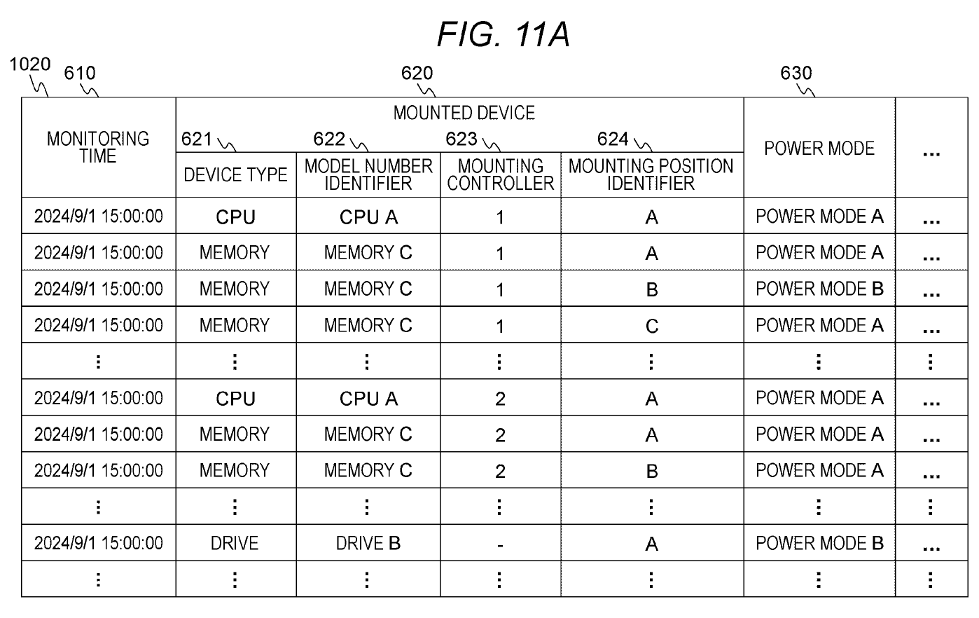

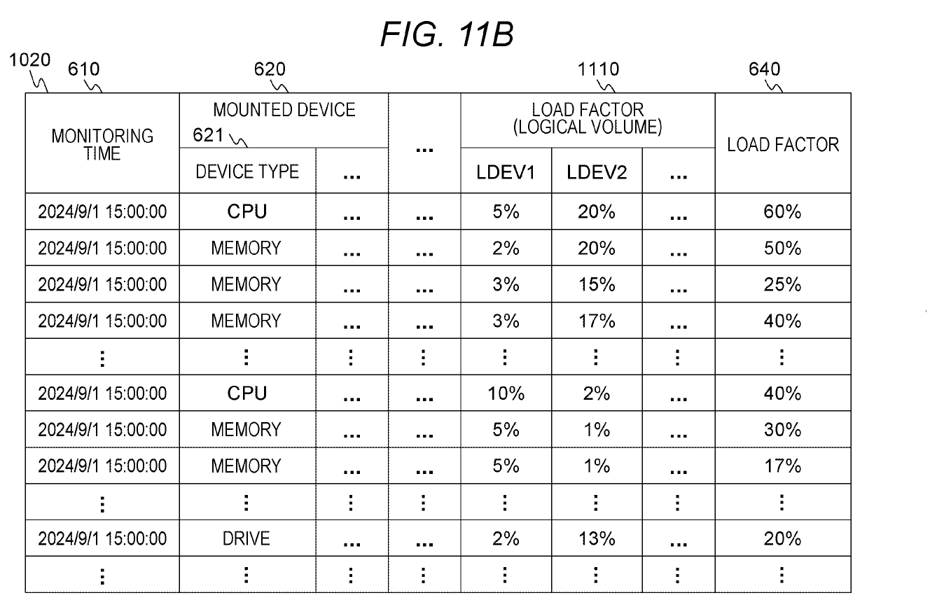

FIGS. 11A and 11B are diagrams illustrating an example of a data structure of the operational history information 1020 according to Example 2. The data structure is divided into two in terms of space in the drawings.

The operational history information 1020 includes a load factor (logical volume) 1110 as compared with the operational history information 320 according to Example 1.

A load factor (logical volume) 1110 is a field where the load factor of the logical volume constructed in the storage system 101 is stored for the mounted device. The operational state monitoring unit 210 determines which logical volume corresponding processing is applied to from address information of data of each storage processing or the like, and records the load factor of each logical volume in the load factor (logical volume) 1110.

In this specification, the logical volume may be referred to as a logical device (LDEV).

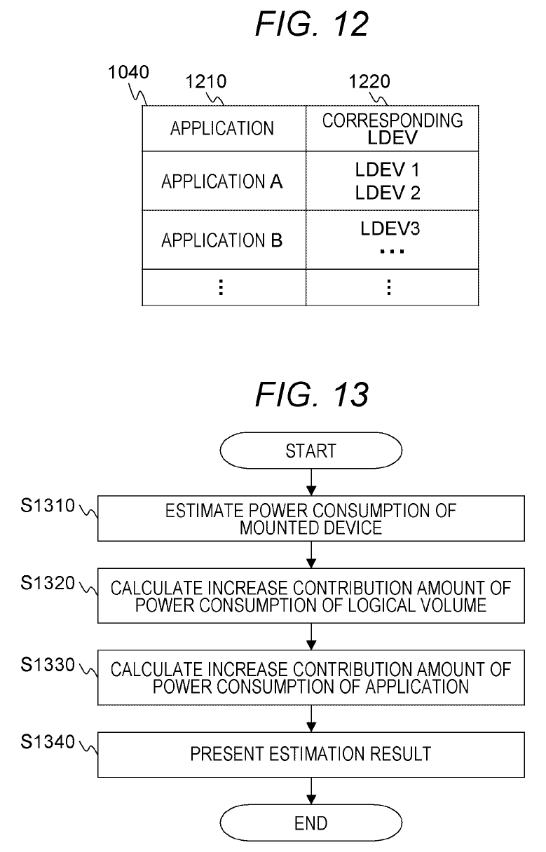

FIG. 12 is a diagram illustrating an example of a data structure of the application configuration information 1040 according to Example 2.

The application configuration information 1040 stores an entry including the application 1210 and a corresponding LDEV 1220. The entry is data for managing association between an application and a logical volume (LDEV).

The application 1210 is a field where identification information of an application operating in the host 102 is stored.

The corresponding LDEV 1220 is a field where identification information of the logical volume used by the application is stored.

Information regarding the application recorded in the application configuration information 1040 is collected from the host 102 by the management terminal 141. Alternatively, an administrator or a user of the storage system 101 may directly input application information to the management terminal 141.

FIG. 13 is a flowchart illustrating power consumption estimation processing executed by the management terminal 141 according to Example 2. In the power consumption estimation processing according to Example 2, an estimation result of power consumption of the storage system 101 is divided in units of applications.

In step S1310, the management terminal 141 estimates power consumption of each mounted device based on an operational history of the operational history information 1020 and the information regarding the corresponding device of the device power reference information 310.

In step S1320, the management terminal 141 calculates an increase contribution amount of power consumption in units of logical volumes. Specifically, for each mounted device, the management terminal 141 calculates an increase amount of power consumption from base power consumption of an operating power mode, calculates a ratio by dividing the load factor of each logical volume by the load factor of the mounted device, and multiplies the increase amount of power consumption by the ratio. The calculated value is set as an increase contribution amount of power consumption in units of logical volumes in the mounted device.

In step S1330, the management terminal 141 calculates an increase contribution amount of power consumption in units of applications with reference to the application configuration information 1040. Specifically, for each mounted device, the management terminal 141 aggregates the increase contribution amount of power consumption of each logical volume unit in units of applications. This is defined as an increase contribution amount of power consumption in units of applications. The management terminal 141 records a power estimation result in the power estimation information 1030.

In step S1340, the management terminal 141 presents the estimation result of the power consumption including the increase contribution amount of power consumption in units of applications to the user via the output device 147.

As described in FIG. 5 of Example 1, in the present invention, since the power consumption of each device is determined in both the power mode and the load, it is assumed that the power consumption nonlinearly increases with respect to the load. Accordingly, in the estimation of the power consumption in units of applications according to the present example, a relative value contributing to an increase in power consumption according to magnitude of a load of each application is calculated.

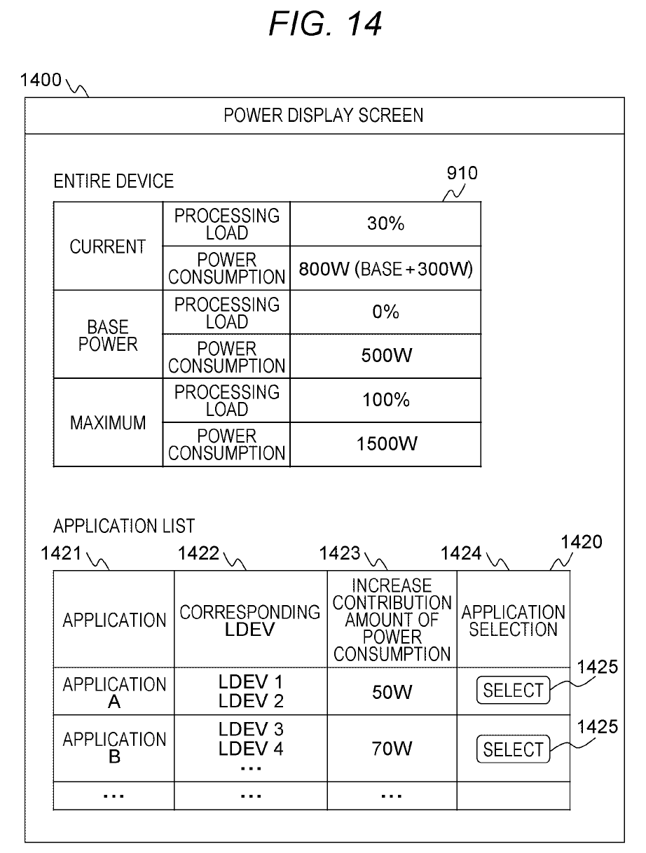

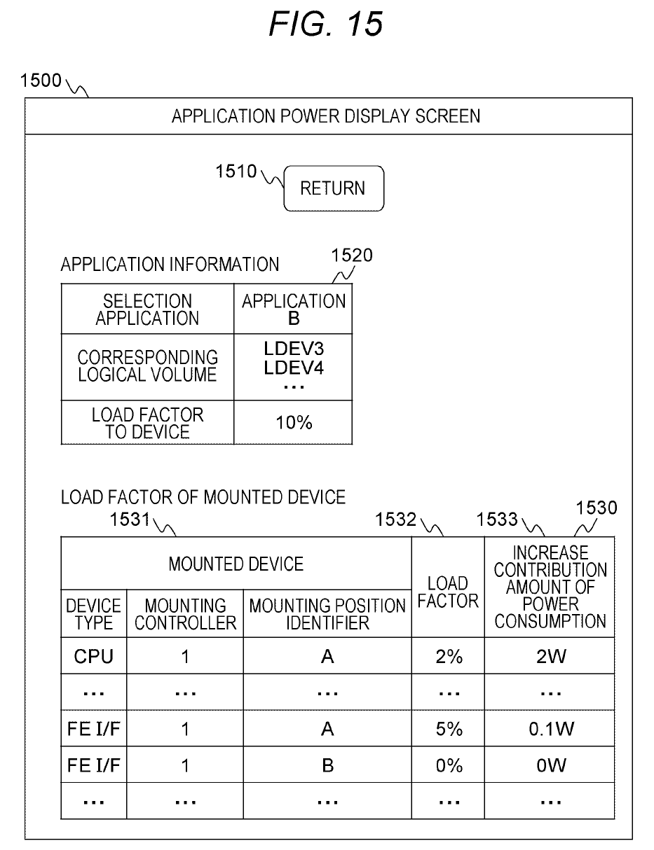

FIGS. 14 and 15 are diagrams illustrating an example of presentation of the estimation result of the power consumption by the management terminal 141 according to Example 2.

The power display screen 1400 includes the entire device power area 910 and an application power area 1420.

The entire device power area 910 is the same as the area described in FIG. 9 of Example 1, and thus the description thereof will be omitted.

The application power area 1420 is an area where a result obtained by dividing the increase amount of power consumption in units of applications from the estimation result of the power consumption of the storage system 101 is displayed.

The application power area 1420 displays entries including an application 1421, a corresponding LDEV 1422, a an increase contribution amount 1423 of power consumption, and an application selection 1424.

The application 1421 and the corresponding LDEV 1422 have the same meaning as the entry of the application configuration information 1040 described in FIG. 12, and thus description thereof will be omitted.

In the increase contribution amount 1423 of power consumption, a power value calculated by the management terminal 141 and corresponding to a contribution amount of each application to an increase in power consumption of the storage system 101 is displayed.

In the application selection 1424, an application selection button 1425 is displayed in order to transition to a more detailed information display screen of each application power consumption estimation result.

The user can transition to the application power display screen 1500 by selecting the application selection button 1425 corresponding to the application of which details are desired to be checked.

The application power display screen 1500 includes a return button 1510, an application information area 1520, and a mounted device load factor area 1530.

The return button 1510 is selected by the user to provide a function of returning to the power display screen 1400.

The application information area 1520 includes, for example, information for identifying the selected application, information regarding a logical volume associated with the application, and information regarding a load factor given to the storage system 101 by the application.

In the mounted device load factor area 1530, an entry including the mounted device 1531, a load factor 1532, and an increase contribution amount 1533 of power consumption is displayed.

The mounted device 1531 is a field group where identification information for identifying the mounted device is stored, and includes a device type, a mounted controller, and a mounting position identifier.

In the load factor 1532, a load factor applied to the mounted device by the selected application is displayed.

The increase contribution amount 1533 of power consumption is a field where an increase contribution amount of power consumption of the device on which the selected application is mounted is stored among the increase contribution amounts of the power consumption in units of applications calculated in the processing described in FIG. 13.

As described above, according to Example 2, the estimation result of the power consumption of the storage system can be divided according to the ratio of the load for each application.

### Example 3

Apart from the problems described in the problems to be solved by the invention, there are the following problems. The estimation technique for dividing the power consumption for each application, as disclosed in PCT International Publication No. WO2011/016081, is used for the purpose of performing control such as application optimization and application stop according to priority using a result of power estimation. In order to optimize power for such a purpose, it is desirable to be able to estimate how much power increases or decreases when the load of the application is changed.

Therefore, in Example 3, a method of simulating a change in power consumption when a load of an application is changed using the power estimation technique described so far will be described.

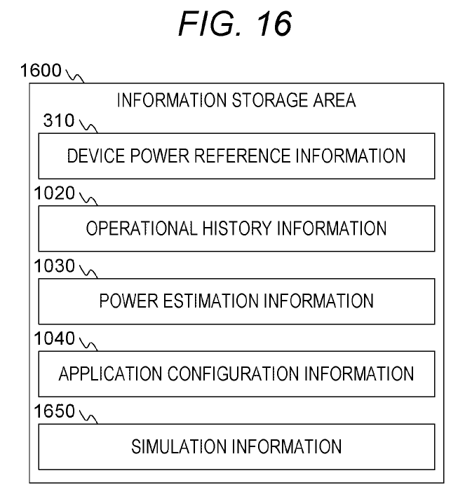

FIG. 16 is a diagram illustrating an example of information stored in an information storage area 1600 of the memory 143 of the management terminal 141 according to Example 3.

In the information storage area 1600, simulation information 1650 is added as compared with the information storage area 1000 according to Example 2. In the simulation information 1650, a result is stored which is obtained by simulating and recalculating information regarding an operational state of the storage system 101 such as the load factor and the power mode when the load of the application is changed.

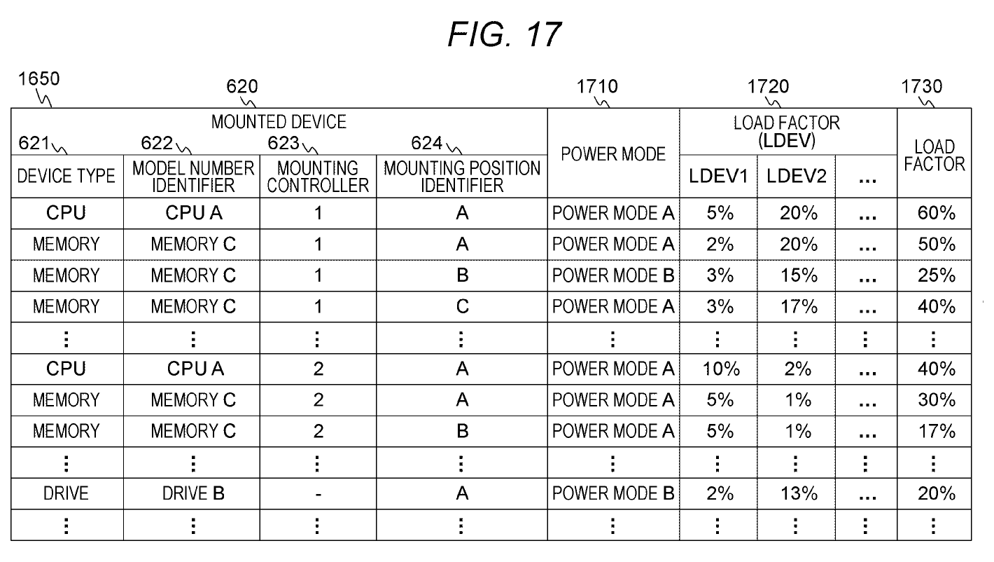

FIG. 17 is a diagram illustrating an example of a data structure of the simulation information 1650 according to Example 3.

In the simulation information 1650, an entry including the mounted device 620, a power mode 1710, a load factor (LDEV) 1720, and a load factor 1730 is stored.

The simulation information 1650 is an area where a result obtained through simulation and recalculation based on the operational history information 1020 of the storage system 101 is stored, and thus has a data structure similar to that of the operational history information 1020. Specifically, the entry of the simulation information 1650 does not include the monitoring time 610 included in the entry of the operational history information 1020. Not a monitoring result but a recalculation result is stored in the power mode 1710, the load factor (LDEV) 1720, and the load factor 1730 of the simulation information 1650.

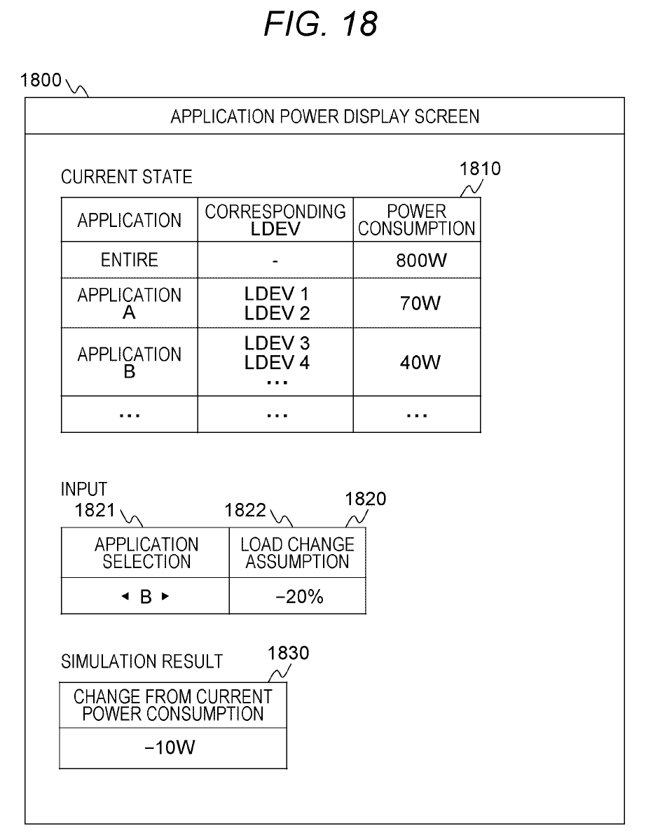

FIG. 18 is a diagram illustrating an example of a power simulation screen 1800 displayed on the output device 147 by the management terminal 141 of Example 3 in order to execute power simulation.

The power simulation screen 1800 includes a current state area 1810, an input area 1820, and a simulation result area 1830.

In the current state area 1810, for example, power consumption of the entire storage system 101, a correspondence relationship between each application and a logical volume, an increase contribution amount of power consumption by each application, and the like are displayed.

The user determines a simulation target application and a load change rate with reference to the information in the current state area 1810.

The input area 1820 includes an application selection 1821 and a load change assumption 1822. The user inputs, to the input area 1820, an application for which a power change is desired to be simulated and a load change amount assumed in the application.

In the simulation result area 1830, the power consumption of the storage system 101 is simulated based on content input by the input area 1820, and how much the power consumption changes from the current power consumption is displayed.

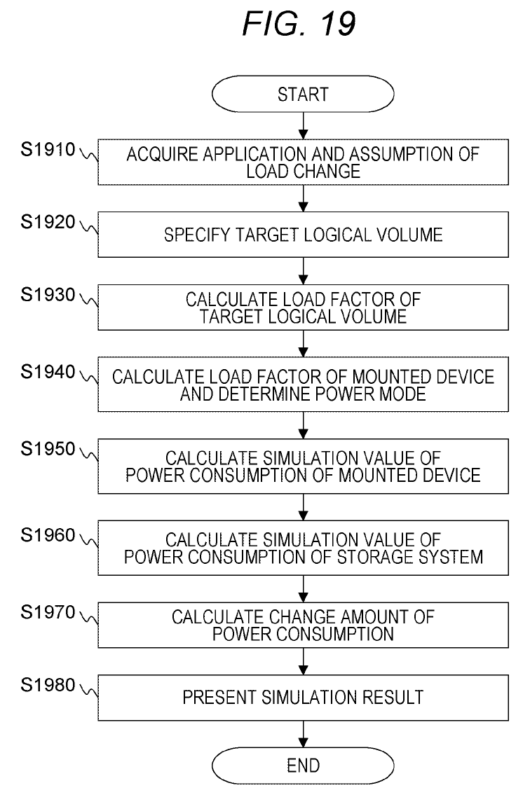

FIG. 19 is a flowchart illustrating a power simulation executed by the management terminal 141 according to Example 3. In the present example, a change in power consumption when the load of the application is changed is simulated.

In step S1910, the management terminal 141 acquires an application desired to be simulated input to the input area 1820 by the user and the assumption of the load change.

In step S1920, the management terminal 141 specifies a logical volume of the target application with reference to the application configuration information 1040.

In step S1930, the management terminal 141 calculates a load factor of a simulation target logical volume to each mounted device with reference to the operational history information 1020. The management terminal 141 records the recalculated load factor in the simulation information 1650. The management terminal 141 transcribes information regarding the operational history information 1020 to the simulation information 1650 for the load factor of the logical volume which is not the simulation target.

The power mode of each mounted device is determined according to the load of each mounted device. Therefore, in step S1940, the management terminal 141 calculates the load factor of each mounted device using the simulation information 1650 and determines the power mode of each mounted device. The management terminal 141 records a sum of the load factors calculated here and the determined power mode in the simulation information 1650.

In step S1950, the management terminal 141 calculates a simulation value of the power consumption of each mounted device with reference to the simulation information 1650 and the device power reference information 310.

In step S1960, the management terminal 141 adds the calculated simulation values of the power consumption of the mounted devices and obtains a simulation value of the power consumption of the storage system 101.

In step S1970, the management terminal 141 calculates a difference between the simulation value of the power consumption of the storage system 101 and the estimation result of the current power consumption.

In step S1980, the management terminal 141 presents the calculation result to the user. Specifically, the management terminal 141 displays a calculation result in the simulation result area 1830 through the output device 147.

As described above, according to Example 3, it is possible to simulate a change in the power consumption when a load of an application is changed using the power estimation technique according to the present invention.

The present invention is not limited to the above-described examples and includes various modifications. For example, the above-described examples have been described in detail in order to describe the present invention in an easy-to-understand manner, and are not necessarily limited to those having all the described configurations. Some of the configurations of the examples can be added to, deleted from, or replaced with other configurations.

Some or all of the above-described configurations, functions, processing units, processing means, and the like may be implemented by hardware, for example, by designing them with integrated circuits. The present invention can also be implemented by a program code of software that implements the functions of the examples. In this case, a storage medium recording the program code is provided to a computer, and a processor included in the computer reads the program code stored in the storage medium. In this case, the program code itself read from the storage medium implements the functions of the above-described examples, and the program code itself and the storage medium storing the program code configure the present invention. As a storage medium supplying such a program code, for example, a flexible disk, a CD-ROM, a DVD-ROM, a hard disk, a solid state drive (SSD), an optical disc, a magneto-optical disk, a CD-R, a magnetic tape, a nonvolatile memory card, a ROM, or the like is used.

The program code implementing the functions described in the present example can be implemented by a wide range of programs or script languages such as assembler, C/C++, perl, Shell, PHP, Python, and Java (registered trademark).

Further, a program code of software implementing the functions of the examples may be distributed via a network to be stored in storage means such as a hard disk or a memory of a computer or a storage medium such as a CD-RW or a CD-R, and a processor included in the computer may read and execute the program code stored in the storage means or the storage medium.

In the above-described examples, the control lines and the information lines indicate what is considered to be necessary for the description, and do not necessarily indicate all the control lines and the information lines on the product. All the configurations may be connected to each other.

What is claimed is:

1. A storage system on which a plurality of devices are mounted,
wherein at least one of the devices operates in a plurality of power modes,
wherein the plurality of devices include a controller and a plurality of storage devices, and
wherein the controller
holds device power reference information for storing data associating types of devices, power modes, and load indexes with power consumption,
acquires an operational history including the power modes and the load indexes of the plurality of devices, and
estimates power consumption of each of the plurality of devices with reference to the device power reference information based on the operational history.

2. The storage system according to claim 1, wherein a first interface for presenting a result of the estimation is provided.

3. The storage system according to claim 2,
wherein at least one logical volume generated by logically dividing storage areas of the plurality of storage devices is provided to an application connected to the storage system,
wherein the operational history includes the load index of each of a plurality of the logical volumes and a load index of the entire device, and
wherein the controller
calculates, for each of the plurality of devices, an increase from base power consumption of the current power mode based on a result of the estimation,
calculates, for each of the plurality of devices, a value obtained by multiplying the increase by a ratio obtained by dividing the load index of each of the plurality of logical volumes by the load index of the entire device as an increase contribution amount of power consumption of the logical volume, and
presents the increase contribution amount of power consumption of the logical volume to the first interface.

4. The storage system according to claim 3, wherein the controller
holds application configuration information for storing data associating the application with the logical volume used by the application,
specifies the logical volume used by the application with reference to the application configuration information,
calculates a value obtained by adding the increase contribution amount of power consumption of the logical volume used by the application as an increase contribution amount of power consumption of the application, and
presents an increase contribution amount of power consumption of the application to the first interface.

5. The storage system according to claim 4, wherein the controller
provides a second interface for inputting the simulation target application and a change amount of a load of the application,
specifies the logical volume used by the simulation target application with reference to the application configuration information,
generates a simulation operational history in which a load index of the specified logical volume included in the operational history of each of the plurality of devices is changed based on a change amount of a load of the simulation target application, and
simulates power consumption of each of the plurality of devices with reference to the device power reference information based on the simulation operational history and presents a result of the simulation via the first interface.

6. A power consumption estimation method executed by a storage system on which a plurality of devices are mounted,
wherein at least one of the devices operates in a plurality of power modes,
wherein the plurality of devices include a controller and a plurality of storage devices, and
wherein the controller holds device power reference information for storing data associating types of devices, power modes, and load indexes with power consumption,
wherein the power consumption estimation method comprises:
a first step of acquiring, by the controller, an operational history including the power modes and the load indexes of the plurality of devices; and
a second step of estimating, by the controller, power consumption of each of the plurality of devices with reference to the device power reference information based on the operational history.

7. The power consumption estimation method according to claim 6, wherein the second step includes providing, by the controller, a first interface for presenting a result of the estimation.

8. The power consumption estimation method according to claim 7,
wherein the storage system provides at least one logical volume generated by logically dividing storage areas of the plurality of storage devices to an application connected to the storage system,
wherein the operational history includes the load index of each of a plurality of the logical volumes and a load index of the entire device, and
wherein the second step includes
calculating, by the controller, for each of the plurality of devices, an increase from base power consumption of the current power mode based on a result of the estimation,
calculating, by the controller, for each of the plurality of devices, a value obtained by multiplying the increase by a ratio obtained by dividing the load index of each of the plurality of logical volumes by the load index of the entire device as an increase contribution amount of power consumption of the logical volume, and
presenting, by the controller, the increase contribution amount of power consumption of the logical volume to the first interface.

9. The power consumption estimation method according to claim 8,
wherein the controller holds application configuration information for storing data associating the application with the logical volume used by the application,
wherein the second step includes specifying, by the controller, the logical volume used by the application with reference to the application configuration information,
calculating, by the controller, a value obtained by adding the increase contribution amount of power consumption of the logical volume used by the application as an increase contribution amount of power consumption of the application, and
presenting, by the controller, the increase contribution amount of power consumption of the application to the first interface.

10. The power consumption estimation method according to claim 9, further comprising:
providing, by the controller, a second interface for inputting the simulation target application and a change amount of a load of the application;
specifying, by the controller, the logical volume used by the simulation target application with reference to the application configuration information,
generating, by the controller, a simulation operational history in which a load index of the specified logical volume included in the operational history of each of the plurality of devices is changed based on a change amount of a load of the simulation target application; and
simulating, by the controller, power consumption of each of the plurality of devices with reference to the device power reference information based on the simulation operational history and presenting a result of the simulation via the first interface.

11. A management terminal connected to a storage system on which a plurality of devices are mounted, the management terminal comprising:
a processor and a storage device connected to the processor,
wherein at least one of the devices operates in a plurality of power modes,
the plurality of devices include a controller and a plurality of storage devices, and
wherein the management terminal
holds device power reference information for storing data associating types of devices, power modes, and load indexes with power consumption,
acquires an operational history including the power modes and the load indexes of the plurality of devices, and
estimates power consumption of each of the plurality of devices with reference to the device power reference information based on the operational history.

12. The management terminal according to claim 11, wherein a first interface for presenting a result of the estimation is provided.

13. The management terminal according to claim 12,
wherein at least one logical volume generated by logically dividing storage areas of the plurality of storage devices is provided to an application connected to the storage system,
wherein the operational history includes the load index of each of a plurality of the logical volumes and a load index of the entire device, and
wherein the management terminal
calculates, for each of the plurality of devices, an increase from base power consumption of the current power mode based on a result of the estimation,
calculates, for each of the plurality of devices, a value obtained by multiplying the increase by a ratio obtained by dividing the load index of each of the plurality of logical volumes by the load index of the entire device as an increase contribution amount of power consumption of the logical volume, and
presents the increase contribution amount of power consumption of the logical volume to the first interface.

14. The management terminal according to claim 13,
wherein application configuration information for storing data associating the application with the logical volume used by the application is held,
wherein the logical volume used by the application is specified with reference to the application configuration information,
wherein a value obtained by adding the increase contribution amount of power consumption of the logical volume used by the application is calculated as an increase contribution amount of power consumption of the application, and
wherein the increase contribution amount of power consumption of the application is presented to the first interface.

15. The management terminal according to claim 14,
wherein a second interface for inputting the simulation target application and a change amount of a load of the application is provided,
wherein the logical volume used by the simulation target application is specified with reference to the application configuration information,
wherein a simulation operational history in which a load index of the specified logical volume included in the operational history of each of the plurality of devices is changed based on a change amount of a load of the simulation target application is generated, and
wherein power consumption of each of the plurality of devices is simulated with reference to the device power reference information based on the simulation operational history and a result of the simulation is presented via the first interface.
